(19) United States
(12) Patent Application Publication
(10) Pub. No.: US 2003/0028379 A1
(43) Pub. Date: Feb. 6, 2003

(54) System for converting electronic content to a transmittable signal and transmitting the resulting signal

(76) Inventors: David M. Wendt, Apex, NC (US); Alicia A. Chastain, Raleigh, NC (US); Christopher J. Paul, Durham, NC (US)

Correspondence Address: Joseph M. Imhof, Esquire, Synnestvedt & Lechner, 2600 Aramark Tower, 1101 Market Street, Philadelphia, PA, 19107-2950, US

(21) Appl. No.: 09/922,539

(22) Filed: Aug. 3, 2001

(51) Int. Cl. G10L 13/08

(52) U.S. Cl. 704/260

(57) ABSTRACT

A system for converting stored electronic content (such as email) to an audible speech signal which is then transmitted such that the content can be received by a receiving device and output as intelligible synthetic speech. A second embodiment of the device allows for a graphic/video element to be included in addition to the audio component.

### BACKGROUND OF THE INVENTION

1. Field of the Invention

The present invention relates to transforming electronic content (such as email) into audible speech signals and transmitting the signals to a receiver.

Text-to-speech technology currently exists that converts machine readable text (e.g., a document generated using a word processor) into intelligible synthetic speech which can then be played through the sound system of a computer. Text-to-speech technology has been used in the telephone industry in situations where one party to a telephone conversation is entering data into a terminal instead of speaking, and outside of the telephone industry, such as in situations where a visually-impaired user of a computer wishes to hear text that is being displayed on the computer monitor. Examples of such technology can be found in U.S. Pat. No. 5,278,943 (Gasper), U.S. Pat. No. 5,991,723 (Duffin), German patent No.198 04 276 A1 (Schrimpf).

The quality of the speech output from the conventional text-to-speech system depends on a combination of the quality of the text-to-speech algorithm used and the sound capabilities of the device being used to provide the audible output. For example, a personal digital assistant (PDA) such as the PalmPilot by 3Com is designed to be portable and provide a convenient way to view text almost anywhere; however, the ability to produce quality sound from a PDA is hampered by its limited audio capabilities and small size. Conversely, a desktop computer system with a sound card and external speakers can produce high quality speech output, but is not convenient for mobile activities.

Therefore, what is desired is a device which will enable small, portable devices with limited sound capabilities (e.g., PDAs) to convert machine readable text to audible speech signals and transmit the audible speech signals to an audio device (e.g., a car stereo system) so that the audible speech signals generate intelligible synthetic speech which is output on the audio device with sufficient capacity to produce quality output.

### SUMMARY OF THE INVENTION

The present invention is a process for reading text in a machine readable format from a content generating device, converting the text to an audible speech signal (text-to-speech conversion), transmitting the audible speech signal to a device capable of receiving the audible speech signal and outputting the text content as audible sound in the form of intelligible synthetic speech. For example, the present invention could be used to take email files stored on a PDA and play the content on a car stereo while driving.

In addition, a second embodiment of the invention can be used with portable devices with limited video capabilities to display a graphic or video element along with the sound, as long as the receiving device has video capability (e.g., a television). In this configuration, an email with an attached graphics file such as a picture could be played on a television whereby the text is heard over the speakers and the picture is displayed on the screen. A program for teaching one a foreign language could be read from a PDA or an E-book and played over a car stereo while driving, or played on a television at home using the audio component and a video component (e.g., an avatar “speaking” the words to aid in learning, or a text depiction of the words to match the audio sound).

### BRIEF DESCRIPTION OF THE DRAWINGS

FIG. 1 is a flowchart illustrating the process of converting machine readable text into an audible speech signal and transmitting the audible speech signal to an FM receiver in accordance with the present invention;

FIG. 2 is a block diagram illustration of a device for performing the process described in FIG. 1;

FIG. 3 is a flowchart illustrating the process of converting the machine readable text with an associated graphic or video element into a television signal format and transmitting the television signal to a TV receiver in accordance with the present invention, and;

FIG. 4 is a block diagram illustration of a device for performing the process described in FIG. 3.

### DETAILED DESCRIPTION OF THE INVENTION

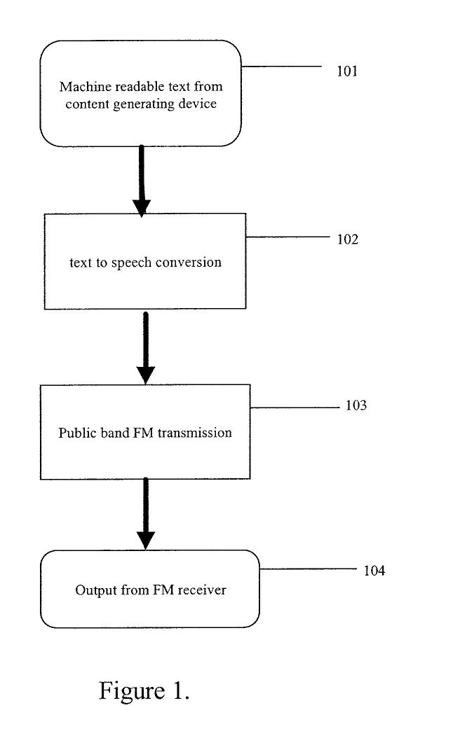

A process for converting text to speech and transmitting the text content to a receiver in accordance with the present invention is shown in FIG. 1. At step 101, machine readable text is received. At step 102, the machine readable text is converted to an audible speech signal in a standard multimedia audio format, such as 16-bit pulse code modulation at an 11,025 Hz sample rate. At step 103, the audible speech signal is transmitted using Frequency Modulation over public FM frequencies using an FM transmitter. Transmitting the audible speech signal allows the audible speech signal to be received and converted to sound by an FM receiver (step 104). By broadcasting in the public FM band, the user can listen to the text content on an ordinary FM radio. The transmitter and the radio can both be tuned to a frequency which is not in use in the user's local area so that there is no interference between the desired audio output and any existing broadcasts. In addition, it is preferred to use a low power FM transmission (50 milliwatts or less) so as to reduce the range of the transmission and thus reduce the likelihood that it will be received outside of the immediate area of the user. This minimizes the chance of reception of the transmission by parties other than the user.

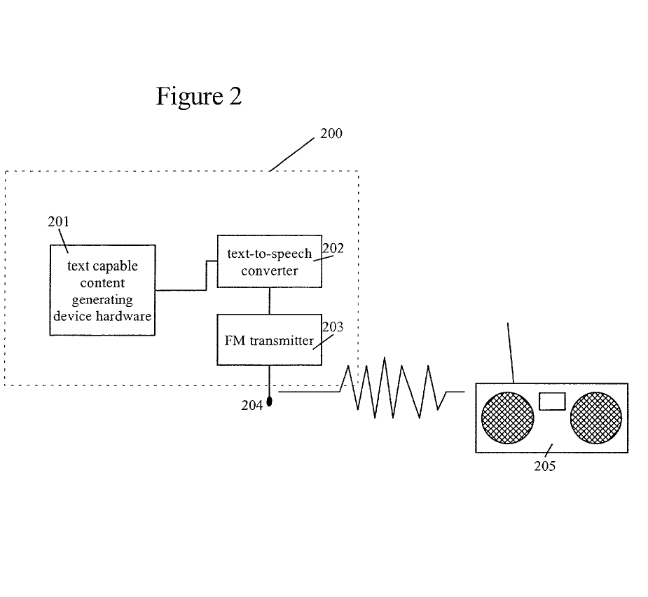

FIG. 2 depicts an example of one embodiment of the process illustrated in FIG. 1. The text is generated from the content generating device 201 such as a PDA, laptop computer, personal computer, or other similar device configured to enable it to generate and display text in a machine readable format. In a well known manner, the content generating device 201 receives text input (for example, via a keyboard) and generates a text message which is displayed on the screen of the device.

The text message is converted to an audible speech signal using a text-to-speech converter 202. This process can be performed using any standard text-to-speech conversion algorithm. Text-to-speech conversion can be accomplished using various known methods, e.g., by formant synthesis (using a mathematical model of the human vocal tract) or speech concatenation (using recorded pieces of real speech). Both of these methods involve conversion of the text to phonemic code. This is accomplished by dividing the sentences of the text into words, and then dividing the words into component parts to yield words in pronounceable form. The phonemic code can be converted to speech waveforms using a speech synthesizer which performs formant synthesis or speech concatenation.

The text-to-speech process can be accomplished using either hardware or software to perform the process. Both hardware and software systems are well known to one skilled in the art. Examples of text-to-speech systems available include the DECtalk Express package or DECtalk software solution (Both manufactured by Force Computers of San Jose, Calif.).

The audible speech signal generated by the text-to-speech converter is in a format which can be directly supplied to an FM transmitter, such as 16-bit pulse code modulation at an 11,025 Hz sample rate, or any other standard multimedia audio format typically used by personal computers.

The audible speech signal in standard audio format is supplied to the FM transmitter 203. Transmitter circuits currently exist which can accept the audible speech signal in standard audio format, perform the required signal modulation, and transmit the signal using a public band FM frequency; one such transmitter circuit is the UK222 Hi-Fi Stereo FM Transmitter manufactured by Canakit Corporation of Burnaby, BC, Canada. The Canakit transmitter circuit utilizes the compact BA1404 stereo broadcaster IC for the generation of the stereo FM signal, thus enabling its use in a handheld device without adding a significant increase in size to the handheld device.

The FM transmitter accepts a signal in the format generated by the text-to-speech converter and broadcasts the signal on the public FM band via the antenna portion 204 of the FM transmitter 203. The broadcast signal is then received by and output on an FM receiving device 205, such as an FM radio.

In the embodiment shown in FIG. 2, the invention is embodied in a single device 200, combining the content generating elements with the conversion and transmission elements. It is also understood, however, that the conversion and transmission elements could be separately combined (i.e., without the content generating element) to form a stand alone device which could then be connected to an output port of an existing content generating device, thereby allowing the present invention to be provided as an after-market item.

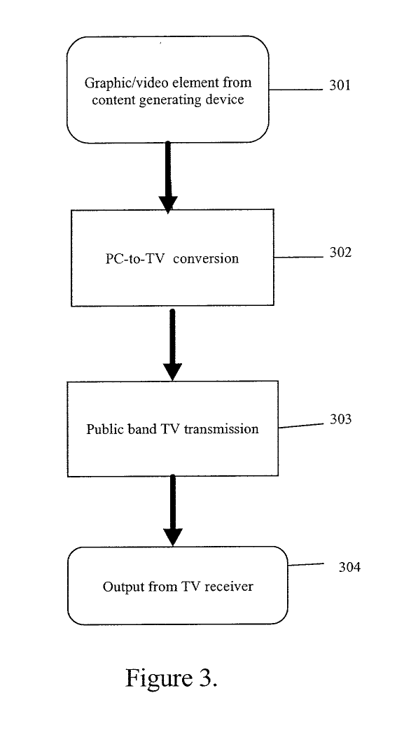

An alternative embodiment is now described in which the present invention is enhanced to provide visual output as well as audio output. FIG. 3 depicts a process which performs the same audio functions described in FIG. 1, but which also includes a graphic/video element. For the purpose of this explanation, only the additional steps required to implement the video aspect are shown; however, it is understood that the process is combined with the process described in connection with FIG. 1 to enable a combined audio/video system.

Referring to FIG. 3, the content generating device (e.g., the PDA or other text generation element) also provides a graphic or video element corresponding in some manner to the text file. For example, this graphic/video element may be a photograph or video image related to the text, or it could be a graphical version of the text itself.

At step 301, the graphic/video element is received from the content generating device in a standard multimedia format, such as a video or computer graphics stream. At step 302, the graphic/video element is converted to a television signal using conventional PC-to-TV conversion. At step 303, the resulting television signal is broadcast on the public UHF or VHF band, and at step 304 the television signal is received by the receiving television tuned to the channel on which the television signal was broadcast, thereby displaying the graphic/video element. This allows the user to view the content from the content generating device as well as listen to an audible version.

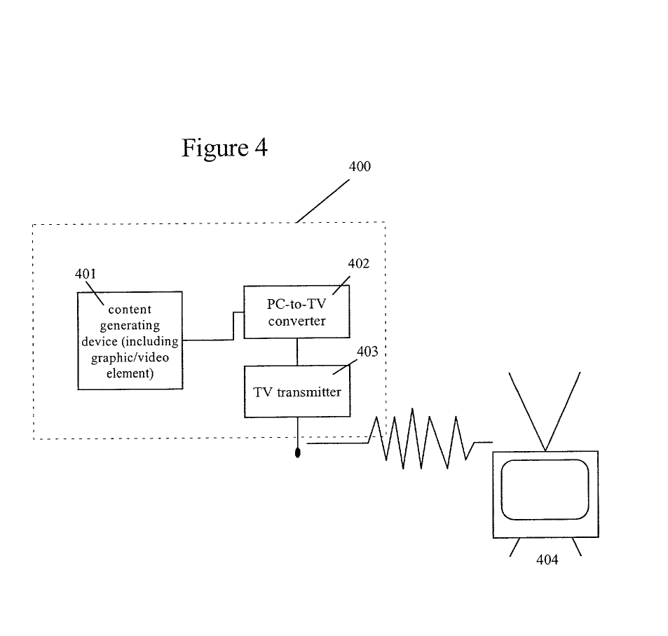

FIG. 4 depicts an example of a structural embodiment of the video-enabled version of the present invention that operates in accordance with the process described in connection with FIG. 3. Referring to FIG. 4, the graphic/video element (as well as any audio element corresponding thereto) is input from the content generating device 401. Such devices include, but are not limited to, PDA's, laptop computers, personal computers, and similar devices. The graphic/video element is input to a PC-to-TV converter using conventional IC circuits or video processors designed to perform the conversion of a video or graphics stream into a television signal. By way of example, one such device is the FS-460 PC-to-TV Co-Processor manufactured by Focus Enhancements, Inc. of Campbell, Calif.

Once converted to a television signal by the PC-to-TV converter 402, the television signal is output and transmitted in a well known manner via a television transmitter 403. The television transmitter 403 can comprise any known transmitter circuit such as the “TV6 Television Transmitter Kit” manufactured by Ramsey Electronics Inc. of Victor, N.Y.

The transmitted signal is received and played as video and/or audio output on a television receiver 404 in a known manner. By broadcasting the television signal using the standard public televison band, a user can receive the transmitted television signal on a channel that is not in use in the user's local area, thereby avoiding interference with local television broadcasts.

The embodiment illustrated in FIG. 4 shows the present invention embodied in a single device 400. It is understood, however, that there are numerous other configurations in which converting and transmitting devices could be separately combined as a stand-alone device which can be connected to an output port of an existing content generating device, thereby allowing the present invention to be provided as an after-market item.

The present invention allows one to convert any text document (e.g., email message) to sound and listen to the content over any FM receiver such as a car stereo. Among other things, the ability to “listen” to a text document in this manner would make a commute to and from work a productive part of one's day. Business travelers could easily play email messages on an FM receiver in their hotel room, and if such messages contain graphic/video elements, the graphic/video elements could be displayed on the hotel television. Web content could be heard and displayed in a similar manner. Computer programs stored on a portable device for teaching foreign languages could be used in a manner such that the words could be heard as the text of the words were displayed visually. Obviously, numerous other applications of the present invention will be readily apparent.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

What is claimed is as follows:

1. A system for converting machine readable text to an audible speech signal and transmitting the resulting signal, comprising;
a text-to-speech converter having an output, said text-to-speech converter converting said machine-readable text code to an audible speech signal and outputting said audible speech signal at said output;
a transmitter coupled to said output of said the text-to-speech converter, said transmitter transmitting the output of said text-to-speech converter as a transmitted audio signal.

2. The system as set forth in claim 1, wherein the transmitted audio signal comprises an FM signal in the public FM band.

3. The system as set forth in claim 1, further comprising a receiver receiving said transmitted audio signal and converting said transmitted audio signal into audible sound.

4. The system as set forth in claim 3, wherein said receiver comprises an FM radio.

5. The system as set forth in claim 1 wherein the machine readable text contains a graphics or video element, said system further comprising;
a PC-to-TV converter having an output, said PC-to-TV converter converting said graphic/video element to a television signal and outputting said television signal at said PC-to-TV converter output; and
a transmitter coupled to the PC-to-TV converter output, said transmitter transmitting the output of said PC-to-TV converter as a television signal.

6. The system as set forth in claim 5, wherein said transmitted signal is in the public television band.

7. The system as set forth in claim 5, further comprising a receiver receiving said transmitted television signal and converting said signal into a viewable picture.

8. The system as set forth in claim 6, wherein said receiver comprises a television.

9. A method of converting machine readable text to a speech signal and transmitting the resulting signal, comprising the steps of;
converting the machine readable text to an audible speech signal; and
transmitting said audio speech signal over a radio frequency in a form that can be received by a radio receiving device.

10. The method as set forth in claim 9, wherein said transmitting step includes at least the step of transmitting said audio speech signal over the public FM band

11. The method as set forth in claim 9, further comprising the steps of;
receiving a graphic/video element;
converting the graphic/video to a televison signal;
transmitting the signal in a form which can be received by a receiving device.

12. The method as set forth in claim 11, wherein said step of transmitting the signal is carried out with a television signal transmitter operating in the public band.
